(19) United States
(12) Patent Application Publication
(10) Pub. No.: US 2024/0284897 A1
(43) Pub. Date: Aug. 29, 2024

(54) Self-Resetting Animal Trap

(71) Applicant: Ricardo Conte-Oro, Hamilton (CA)

(72) Inventor: Ricardo Conte-Oro, Hamilton (CA)

(21) Appl. No.: 18/114,386

(22) Filed: Feb. 27, 2023

(51) Int. Cl. A01M 23/14; A01M 23/04

(52) U.S. Cl. CPC A01M 23/14; A01M 23/04

(57) ABSTRACT

A trap for animals that automatically resets and preserves bait. The self-resetting animal trap includes an upper chamber having a bait chamber removably covered by an entrance gate and a bait lid, respectively. A trap gate forms a floor of the upper chamber, wherein a lower chamber for receiving a trapped animal is disposed therebeneath. The trap gate, entrance gate, and bait lid are pivotally connected to one another and move between a set configuration and a trap configuration. In the set configuration, the entrance gate and bait lid are open, and, in the trap configuration, the trap gate is open. The trap is biased to the set configuration due to a counterweight disposed on an end of the entrance gate. The counterweight is offset when an animal is disposed on the trap gate, thereby moving the self-resetting animal trap to the trap configuration.

### BACKGROUND OF THE INVENTION

The present invention relates to an animal trap. The present invention provides a self-resetting animal trap operated via gravity and configured to automatically reset.

Rodents and other pests create environmental problems for landowners, homeowners, and the like. For example, birds and squirrels tend to infest gardens and houses where they cause damage attic roofs, sidewalks, food, and plants. The use of traditional animal traps has been a prevalent method for controlling unwanted animal populations for many years. However, these traps have several limitations that have become increasingly apparent. Firstly, traditional animal traps often require electricity or gas to function, which makes them dependent on external power sources and limits their usage in remote areas.

Additionally, many traditional animal traps have overly complex mechanical operations, which can make them difficult to set up and maintain. This can lead to traps malfunctioning, which can result in the animal escaping or being harmed. Furthermore, traditional animal traps can also cause harm to the trapped animal. This can happen if the animal is not killed quickly and humanely, or if the trap causes injury to the animal before it is killed.

Many traditional traps use bait that must be continuously replaced, adding to the cost and inconvenience for the user. This can lead to significant expenses and additional labor in order to maintain the trap and feeding the unwanted rodent. Therefore, there exists a need for a more efficient and humane animal trap that operates exclusively via gravity, automatically resets and preserves the bait used to trap the animal.

In light of the devices disclosed in the known art, it is submitted that the present invention substantially diverges in design elements and methods from the known art and consequently it is clear that there is a need in the art for an improvement for a self-resetting animal trap. In this regard the instant invention substantially fulfills these needs.

### SUMMARY OF THE INVENTION

In view of the foregoing disadvantages inherent in the known types of self-resetting animal traps now present in the known art, the present invention provides a self-resetting animal trap wherein the same can be utilized for trapping an animal, via gravity, while preserving the bait.

It is an objective of the present invention to provide a self-resetting animal trap comprising a lower chamber and an upper chamber, wherein the upper chamber comprises an entrance gate and an opposing trap gate, wherein the entrance gate provides access to an interior volume of the upper chamber and the trap gate provides access to an interior volume of the lower chamber.

It is another objective of the present invention to provide a self-resetting animal trap comprising a bait chamber having a bait lid, wherein the bait chamber is disposed within the upper chamber and connected to the entrance gate such that the bait lid and the entrance gate open and close simultaneously.

It is another objective of the present invention to provide a self-resetting animal trap wherein the trap gate, entrance gate, and bait lid are pivotally connected to one another and move between a set configuration and a trap configuration. In the set configuration, the entrance gate and bait lid are open, and the trap gate is closed, and, in the trap configuration, the entrance gate and bait lid are closed, and the trap gate is open. The trap is biased to the set configuration due to a counterweight disposed on an end of the entrance gate. The counterweight is offset when an animal is disposed on the trap gate, thereby moving the self-resetting animal trap to the trap configuration. Once the trap gate releases the animal into the lower chamber, the counterweight automatically returns the trap to the set configuration.

It is yet another objective of the present invention to provide a self-resetting animal trap wherein the lower chamber comprises an exit door.

It is yet another objective of the present invention to provide a self-resetting animal trap that utilizes gravity to reset the trap without the need for electricity, gas, or complex mechanical operation so it can be used easily, even in remote locations.

It is yet another objective of the present invention to provide a self-resetting animal trap that does not harm the trapped animal and can be used in a humane manner.

It is another objective of the present invention to provide a self-setting animal trap that uses bait that can be preserved and reused, reducing the cost and inconvenience for the user.

It is another objective of the present invention to provide a self-setting animal trap that automatically resets itself after each successful trapping, allowing it to trap multiple animals without the need for manual resetting.

It is therefore an object of the present invention to provide a new and improved new a self-resetting animal trap that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

FIG. 1 shows a perspective view of an embodiment of the self-resetting animal trap, wherein the self-resetting animal trap is in a set configuration.

FIG. 2 shows a perspective view of an embodiment of the self-resetting animal trap, wherein the self-resetting animal trap is in a trap configuration.

FIG. 3 shows a side view of an embodiment of the self-resetting animal trap.

FIG. 4 shows a front view of an embodiment of the self-resetting animal trap.

FIG. 5 shows a front view of a lower chamber of an embodiment of the self-resetting animal trap, wherein the first and third sides are transitioning to a collapsed configuration.

FIG. 6 shows a side view of a lower chamber of an embodiment of the self-resetting animal trap, wherein the second, fourth and fifth sides are transitioning to a collapsed configuration.

### DETAILED DESCRIPTION OF THE INVENTION

Reference is made herein to the attached drawings. For the purposes of presenting a brief and clear description of the present invention, the preferred embodiment will be discussed as used for trapping an animal while preserving the bait. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

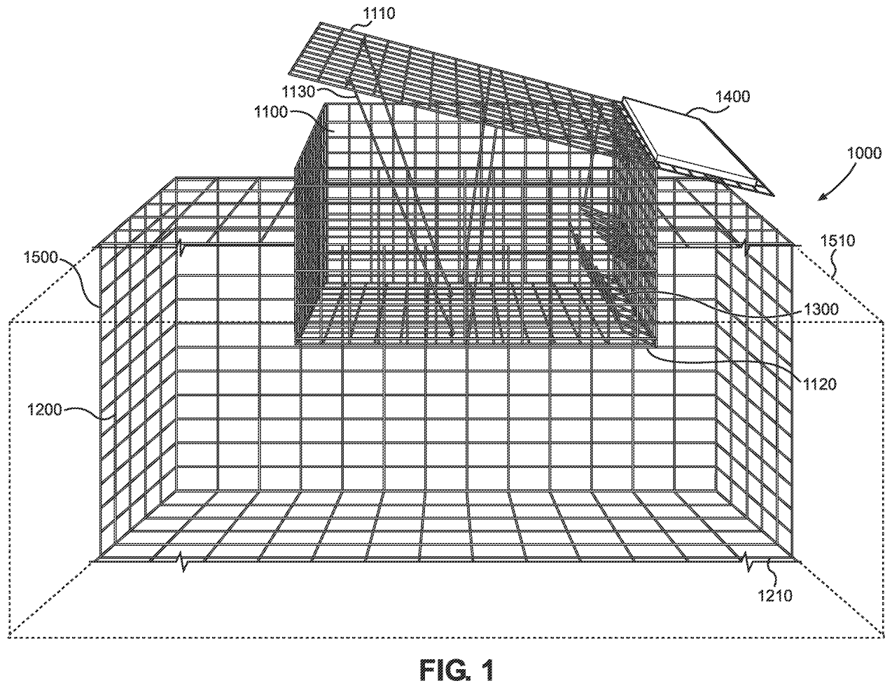

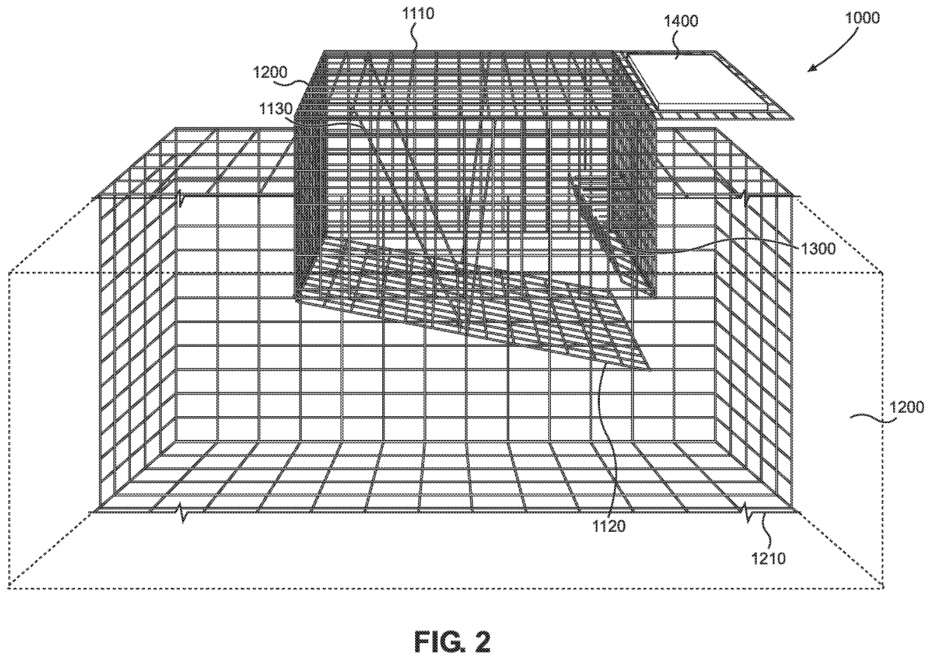

Referring now to FIGS. 1 and 2, there are shown perspective views of an embodiment of the self-resetting animal trap, wherein the self-resetting animal trap is in a set configuration and a trap configuration, respectively. The current views are partially cutaway to better illustrate an interior of the animal trap without the hinderance of an exterior sidewall (shown in broken lines). The self-resetting animal trap 1000 comprises an upper chamber 1100 disposed above a lower chamber 1200, wherein the upper chamber 1100 is configured to temporarily receive an animal and the lower chamber 1200 is adapted to receive the animal until a user is ready to remove the animal from the trap 1000. In the illustrated embodiment, the upper and lower chambers 1100, 1200 are each composed of interconnected wires forming a cage having a series of openings. In alternate embodiments, the chambers are composed of any suitable structure configured to receive an animal, such as chambers having rigid, solid walls or soft, flexible walls. The purpose of the wires forming the cage-like structure of each chamber is to prevent an animal from easily escaping or damaging the chambers by chewing therethrough. The series of openings further allow the animal to breath when trapped within the lower chamber 1200.

The lower chamber 1200 comprises a base 1210 configured to rest atop a surface, a sidewall 1220, and an upper end 1230. In the illustrated embodiment, the lower chamber 1200 comprises a rectangular shaped cross section, however, in alternate embodiments, the lower chamber comprises any suitable cross-sectional shape. In alternate embodiments, the self-resetting animal trap 1000 is configured to be suspended from a secondary structure, such as a tree, such that the base is not in contact with a support surface.

The upper chamber 1100 is partially disposed through the upper end 1230 of the lower chamber 1200 and comprises an entrance gate pivotally secured to an open upper end 1110 thereof and a trap gate 1120 forming a floor of the upper chamber 1100. In the illustrated embodiment, the entrance gate 1110 is disposed above the lower chamber 1200 and the trap gate is disposed within the interior volume of the lower chamber 1200. The trap gate 1120 provides access to the lower chamber 1100 when in an open position. In the illustrated embodiment, the entrance gate 1110 and trap gate 1120 entirely cover their respective opening of the upper chamber 1100.

The entrance gate 1110 and trap gate 1120 are pivotally connected to each other via a pair of rods 1130. Each pivot rod 1130 comprises a first end connected to the entrance gate and a second end connected to the trap gate, along the same side of the upper chamber 1100. The trap gate 1120 is configured to open within the lower chamber 1200 when weight from an animal is received thereupon. In this way the self-resetting animal trap 1000 uses gravity to trap and contain the animal within the lower chamber 1200. In the illustrated embodiment, the entrance gate 1110 and the trap gate 1120 open on opposite sides. The entrance gate 1110 is configured to open at a front side 1500 of the self-resetting animal trap 1000 and the trap gate 1120 is configured to open at a rear side 1510 of the self-resetting animal trap 1000.

A bait chamber 1300 is disposed within the upper chamber 1100 and configured to lure the animal therein. The bait chamber 1300 comprises a bait lid 1310 and a wall 1320 extending from a sidewall 1130 of the upper chamber 1100, such that a closure is formed when the bait lid 1310 is resting along the wall 1320. In the shown embodiment, the bait lid 1310 is connected to the entrance gate 1110 via a rod 1330, such that the entrance gate 1110 and bait lid 1310 close and open simultaneously. In the illustrated embodiment, the bait lid 1310 and entrance gate 1110 are parallel to one another such that when the entrance gate 1110 and bait lid 1310 are horizontal, the upper chamber 1100 and bait chamber 1300 are closed.

The self-resetting animal trap 1000 comprises a biasing member, such as a counterweight 1400 that extends from the upper chamber 1100. In the illustrated embodiment, the counterweight 1400 extends from and is coplanar with the entrance gate 1110 to maintain the entrance gate 1110 and bait lid 1310 in an open position until the weight from the animal is received upon the trap gate 1120 and offsets the counterweight 1400. The weight of the counterweight 1400 is dependent upon the type of animal the user is attempting to trap. A heavier counterweight 1400 is used for larger animals and a lighter counterweight 1400 is used for smaller animals. In some embodiments, the counterweight 1400 is interchangeable. In the illustrated embodiment, the counterweight 1400 is a rectangular member that is disposed on the exterior of the sidewall 1130 of the upper chamber 1100 and pivots about a perimeter edge of an uppermost end thereof.

In other embodiments, the biasing member comprises a spring operably connected to the entrance gate such that the biasing force urges the entrance gate open. In other embodiments, the biasing member is a magnet.

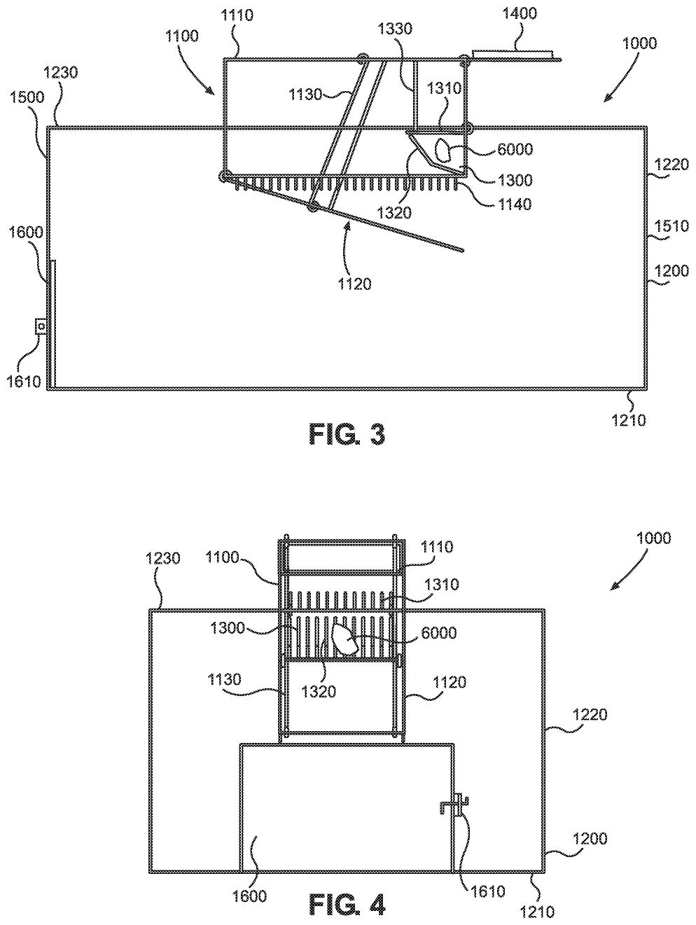

Referring now to FIGS. 3 and 4, there is shown a side view and a front view of an embodiment of the self-resetting animal trap wherein the self-resetting animal trap is in a trap configuration, respectively. In the illustrated views, the intersecting wires of each chamber are removed for clarity of the details. In the illustrated embodiments, the lower chamber 1100 comprises an exit door 1600 disposed along the sidewall 1220 to allow the user to selectively remove the animal therefrom. In the illustrated embodiment, the exit door 1600 comprises a locking mechanism 1610, such as a latch. The exit door 1600 comprises a pivotally connected to the lower chamber 1200 on an opposing side of the locking mechanism 1610.

In some embodiments, a perimeter of the trap gate 1120 comprises barbs 1140 in order to deter the animal from manipulating the trap gate 1120 to attempt to reenter the upper chamber 1100 once disposed in the lower chamber 1200.

In the illustrated embodiment, the trap gate 1120, entrance gate 1110, and bait lid 1310 are pivotally connected to one another and move between a set configuration and a trap configuration. In the set configuration, the entrance gate 1110 and bait lid 1310 are open, and the trap gate 1120 is closed (as seen in FIG. 1). In the trap configuration, the entrance gate 1110 and bait lid 1310 are closed, and the trap gate 1120 is open. The self-resetting animal trap 1000 is biased to the set configuration due to a counterweight 1400 disposed on an end of the entrance gate 1110. The counterweight 1400 is offset when an animal is disposed on the trap gate 1120, thereby moving the self-resetting animal trap 1000 to the trap configuration. Once the trap gate 1120 opens into the lower chamber 1200, the animal falls into the lower chamber 1200. As soon as the weight of the animal is no longer on the trap gate 1120, the counterweight 1400 automatically returns the trap 1000 to the set configuration. Therefore, the trap 1000 is continuously reset and configured to trap multiple animals.

As a result, once the animal is within the upper chamber 1100, the trap gate 1120 immediately starts opening and the bait lid 1310 simultaneously closes, thereby preventing access to the bait chamber 1300 and preserving the bait 6000 for the next trap or animal.

The illustrated embodiment of the self-resetting animal trap 1000 is only gravity activated and does not require the use of springs or other mechanical methods to move the device between a set configuration and a trap configuration. The use of a counterweight eliminates some of the problems associated with springs, such as rusting or stretching, which can change the amount of force applied by the spring.

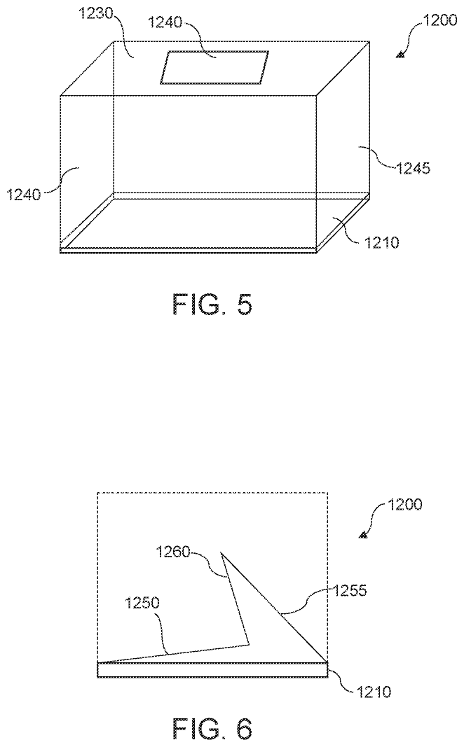

Referring now to FIGS. 5 and 6, there is shown a perspective view of a lower chamber of an embodiment of the self-resetting animal trap and a front view of a lower chamber of an embodiment of the self-resetting animal trap, wherein the second, fourth and fifth sides are transitioning to a collapsed configuration, respectively. The walls of the lower chamber in the present illustrations are transparent for clarity. In some embodiments, the upper chamber is separable from the lower chamber 1200, for compact storing. In the illustrated embodiment, an opening 1240 is formed in the upper end 1230 of the lower chamber 1200 when the upper chamber 1100 is removed therefrom. The remaining walls of the lower chamber 1200 are hingedly secured to one another and can be folded into the base 1210. In the illustrated embodiment, a first sidewall 1245 and an opposing third sidewall 1250 of the lower chamber 1200 are configured to fold toward the base 1210 thereof. The base 1210 forming a planar floor of the lower chamber 1200. Once the first and third sides are folded, a second side 1250 and an opposing fourth side 1255 are configured to fold toward the base, such that the sides of the lower chamber are stacked on one another in a collapsed configuration. In other embodiments, the fifth side 1260 or top side is connected between the fourth and second sides and is configured to fold therewith onto the base.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A self-resetting animal trap, comprising:
an upper chamber having an entrance gate and an opposing trap gate, wherein the entrance gate provides access to an interior volume of the upper chamber;
wherein the entrance gate and trap gate are operably connected to each other via a pair of connecting arms;
a bait chamber disposed within the upper chamber adapted to house bait;
wherein the animal trap is adapted to transition from a set configuration to a trap configuration when an animal is positioned on the trap gate within the upper chamber;
in the set configuration, the entrance gate is open and the trap gate is closed, thereby allowing access to the upper chamber;
in the trap configuration, the entrance gate is closed, and the trap gate is open, wherein the trap gate is adapted to provide access from the upper chamber to a lower chamber when in the trap configuration, wherein the lower chamber is sized to house an animal therein;
a biasing member operably connected to the entrance gate and trap gate, wherein the biasing member applies a biasing force that causes the entrance gate open and trap gate closed;
wherein the biasing force is adapted to be overcome when an animal is disposed on the trap gate, thereby transitioning from the set configuration to the trap configuration;
wherein the biasing member is configured to automatically return to the set configuration when the animal is not disposed on the trap gate.

2. The self-resetting animal trap of claim 1, wherein the upper chamber is separable from the lower chamber and the lower chamber is collapsible.

3. The self-resetting animal trap of claim 2, wherein a first side and an opposing third side of the lower chamber are configured to fold toward a base of the lower chamber and a second side and an opposing fourth side are configured to fold toward the base, such that the sides of the lower chamber are stacked on one another in a collapsed configuration.

4. The self-resetting animal trap of claim 1, wherein the entrance gate and the biasing member are coplanar.

5. The self-resetting animal trap of claim 1, wherein the upper chamber is partially disposed within the interior volume of the lower chamber, such that the entrance gate is disposed above the lower chamber and the trap gate is disposed within the interior volume of the lower chamber.

6. The self-resetting animal trap of claim 5, wherein the entrance gate is entirely exterior to the lower chamber and the trap gate is entirely interior to the lower chamber.

7. The self-resetting animal trap of claim 1, wherein the lower chamber comprises an exit door, the exit door comprising a latch locking mechanism to prevent the exit door from opening.

8. The self-resetting animal trap of claim 1, wherein the upper chamber and lower chamber are composed of rigid interconnecting wires forming a series of openings.

9. The self-resetting animal trap of claim 1, wherein the bait chamber comprises a bait lid, the bait lid is operably connected to the entrance gate such that when the entrance gate is open the bait lid is open, and wherein the entrance gate is closed, the bait lid is closed.

10. The self-resetting animal trap of claim 1, wherein the bait chamber is disposed entirely at a rear end of the upper chamber, opposite an opening of the entrance gate.

11. The self-resetting animal trap of claim 1, wherein the entrance gate and the trap gate open on opposite sides of the upper chamber.

12. The self-resetting animal trap of claim 1, wherein the biasing member is a counterweight.

13. The self-resetting animal trap of claim 12, wherein the counterweight is positioned on side opposite the entrance gate, wherein a pivot is disposed between the counterweight and entrance gate.

14. The self-resetting animal trap of claim 12, wherein the counterweight comprises a planar member disposed on an exterior of a sidewall of the upper chamber and pivots about a perimeter edge of an uppermost end of the upper chamber.

15. The self-resetting animal trap of claim 1, wherein the biasing member is a spring.

16. The self-resetting animal trap of claim 1, wherein the biasing member is a magnet.
